(19) United States
(12) Patent Application Publication
(10) Pub. No.: US 2019/0367368 A1
(43) Pub. Date: Dec. 5, 2019

(54) FORMULATION FOR THE SYNTHESIS OF THERMAL NANOFLUID BASED ON CARBON NANODOTS

(71) Applicant: RESEARCH INSTITUTE OF PETROLEUM INDUSTRY, Tehran (IR)

(72) Inventors: Alimorad RASHIDI, Tehran (IR); Amir YADEGARI, Tehran (IR); Ehsanollah ETTEFAGHI, Tehran (IR); Saeid KHODABAKHSHI, Shiraz (IR); Roghayeh LOTFI, Tehran (IR); Maryam RASHTCHI, Tehran (IR)

(73) Assignee: RESEARCH INSTITUTE OF PETROLEUM INDUSTRY, Tehran (IR)

(21) Appl. No.: 16/461,318

(22) PCT Filed: Nov. 17, 2016
(86) PCT No.: PCT/IB2016/001640

§ 371 Date: May 15, 2019

(51) Int. Cl. C01B 32/158; C09K 5/10

(52) U.S. Cl. CPC C01B 32/158; B82Y 30/00; C09K 5/10

(57) ABSTRACT

The present invention relates to the formulation of nanofluids including carbon dot nanoparticles with particle sizes of 10 nm or less and base fluid. The term “carbon dot nanoparticles” means one or any combination of carbon quantum dots, graphene quantum dots, graphene nanodots, graphene oxide nanodots, carbon nanotubes dots, and carbon nanostructures whose specifications are consistent with those cited in the invention background section in detail. The nanofluid of the present invention is economical and environmentally friendly. Moreover, the nanofluid composition of the invention has suitable stability and capability of heat transfer required by industry.

### TECHNICAL FIELD

The present invention relates to nanofluids containing carbon nanodots. It is also related to methods for production of nanofluids containing carbon nanodots. The terms “nanofluid”, “nanofluid composition” and “fluid composition” are used interchangeably in the present application. Furthermore, the term “carbon dot nanoparticles”, “carbon nanodots” and “carbon dots” are used interchangeably.

### BACKGROUND OF THE INVENTION

These days, the issue of energy has become the key issue in the world. High and growing costs of fossil fuels and concerns about the problem of depletion of these non-renewable resources have made the owners of large industries make great efforts to find solutions to the reduction of energy consumption and improve its efficiency. In today's global community, the environmental pollutions resulting from industrialization have attracted the attention of researchers to find renewable and environmentally friendly resources of energy and their optimal use. Therefore, advanced materials and nanomaterials have found applications in the area of energy including the sectors of generation, storage, and saving that in each sector they lead to the improvement of the properties of materials, processes, consumption reduction, and saving. For example, in the sector of energy saving one can mention the issues of nanofluids in which reduction in the volume of heat exchanger and also in the consumption of the exchanger fluid (fluids like water, ethylene glycol, and mixture of water and ethylene glycol) is done by the use of nanomaterials in different industries. The initial goals of the present research and development of nanofluids are the discovery of unparalleled properties of nanoparticles for the development of heat transfer fluids containing stable and dispersed particles with high heat transfer capability (thermal conductivity and convection). The thermal conductivity of old heat transfer fluids such as lubricants, engine coolants, and water is inherently low. Two general methods are used for the development of nanofluids. One is the two-stage method by which the nanoparticles are first made and are then dispersed in the base fluid phase. The second method is the single-stage method in which the nanoparticles are simultaneously and directly made and dispersed in the base phase. The two-stage methods are more conventional and less costly than the single-stage methods. The two-stage methods can be employed for the production of nanofluids with nanoparticles and different base fluids. The preparation of nanofluids in the two-stage method is not as simple as the production of common liquid/solid mixtures. The very serious problem that spoils the production of nanofluids is the agglomeration of nanoparticles in the fluid (i.e. those resulting in precipitation) and by a reduction in the size of the particles of nano-dimension, agglomeration also increases. The common methods for having access to stable nanofluid with no agglomeration are the change of acidity, functionalization of the particle surface, use of surfactants, ultra-sonic vibrators, etc. Due to the existence of very strong Van der Waals interactions, nanoparticles always aggregate together and form a mass and precipitate in specific size.

Also, some methods like changing pH and/or adding surfactants in high concentration used to stabilize nanoparticles result in an inappropriate change in the performance of the fluid inside mechanical systems (e.g. corrosion of parts, foaming, etc.). On the whole, long-term stability of nanoparticles inside the base fluid is one of the basic necessities for the use of nanofluids. The stability of nanoparticles has a very good comparative relationship with the improvement of nanofluid conductivity. The more the dispersion of the particles, the more the heat transfer of nanofluid increases and on the other hand, damage to mechanical systems and blockage resulting from the precipitation of nanoparticles is minimized.

One of the features considered for the use of nanofluids is an increase in the heat transfer capability of the conventional heat transfer fluids. According to the studies performed, a variety of factors such as size, substance, shape, concentration of nanoparticles, temperature, type of the base fluid, type of flow regime (laminar or turbulent flow), compositions added to the nanofluid and many of other factors are effective in determining the features of nanofluids and the rate of their heat transfer capability (unfortunately, no precise and comprehensive relation has yet been obtained for the prediction and determination of physical features of nanofluids and all the existing relations are experimental which are different for different samples). Although there are some findings in various references showing the reduction in the heat transfer of nanofluids with a reduction in the size of the particles due to the high tendency of finer particles to coagulate, an increase in the capability of heat transfer with a reduction in the size of the nanoparticles is a more acceptable theory and two theoretical mechanisms, i.e. Brownian motion of particles and stratification of fluids around the particles support it. That is because the Brownian motion and specific surface increase with the size of nanoparticles growing smaller.

It should also be considered that the clustering of nanoparticles up to a favorable point (before the stage of precipitation) increasing with a reduction in the size of particles also improves heat transfer, since heat paves a rather long path along the length of the created clusters and the fluid molecules form stratified structures around the solid particles; it is expected that these nanolayers enjoy more effective conductivity compared with the bulk of liquid phase.

Additionally, according to Lenard-Jones Forces and the relation between speed of precipitation and the particle size, another advantage of reduction in the size of nanoparticle is the higher stability of nanofluid.

Also, Brownian motion related to irregular motion of particles resulting from molecular shocks on the surface of liquid increases with a reduction in the size of the particles.

So far, different nanoparticles have been used for the preparation of nanofluids. Generally, for the synthesis of water-based heat transfer nanofluids in different research activities, different types of metallic nanoparticles, metal oxide, multi-walled carbon nanotubes (MWCNT), single-walled carbon nanotubes (SWCNT), and graphene with a particle size of 10-100 nm and with different concentrations within the range of 0.1-10 wt % have been used which are not of significant improvement to some extent in achieving heat transfer. Also, studies show that different types of chemical surfactants with weight concentrations up to 10 times that of the nanoparticles are used for the stabilization of nanoparticles inside the fluid.

Fluorescent carbon nanoparticles or Carbon quantum dots (CDs) as the new generation of carbon nanoparticles was accidently discovered by Zhu et al. in 2004 while separating and purifying the single-walled nanotubes (Lim, S. Y., Shen, W. and Gao, Z., Carbon quantum dots and their applications, Chemical Society Reviews, 44, 362-381, 2015.).

In addition to their optical and fluorescent properties, carbon nanodots enjoy favorable advantages such as low toxicity, environmentally friendliness, low cost, and simple methods of synthesis. Also, the possibility of functionalizing the surface of carbon nanodots permits the control of their physicochemical properties.

Carbon nanodots (carbon dots) include carbon quantum dots, graphene quantum dots, graphene nanodots, graphene oxide nanodots, carbon nanotubes dots and carbon nanostructure with the below said specifications and combinations thereof. Preferred carbon nanodots are selected from the group consisting of carbon quantum dots, graphene quantum dots, graphene nanodots, graphene oxide nanodots, carbon nanotubes dots and combinations thereof with the below said specifications. Carbon nanodots are generally spheroidal nanoparticles with diameters less than 20 nm consisting of amorphous nucleus up to nanocrystals with dominant graphite (carbon SP²) or graphene and oxidized graphene sheets or diamond-like hybrid carbon (SP³) (FIG. 1). In general, carbon nanodots include 1 to 20 weight percentages of oxygen-containing groups such as carboxylic groups (COOH), hydroxyl (OH), etc. In case the precursors used in the synthesis of carbon dots include nitrogen atom, the amine groups exist in the form of functional groups of C—N, N—H, and N—H₂.

Furthermore, pyridinic and pyrolic structures are formed in doped form in the structure of carbon nanodots.

Carbon nanodots are produced by top-down and bottom-up methods. Methods of top-down include the breakage of larger carbon structures such as nano-diamonds, graphite, graphene, carbon nanotubes, carbon black, activated carbon, and graphite oxide by methods such as electric arc discharge, laser ablation, and electrochemical oxidation. On the other hand, the bottom-up methods are employed for the production of carbon nanodots by the use of molecular precursors like citrate (citric acid salt), carbohydrates, and silica-polymer nanocomposite during combustion or an increase in temperature and microwave methods. For example, Zhu et al. (Zhu, H., Wang, X., Li, Y., Wang, Z., Yanga, F. and Yang, X., Microwave synthesis of fluorescent carbon nanoparticles with electrochemiluminescence properties, Chemical Communications, 34, 5118-5120, 2009.) showed that carbon quantum dots are easily formed by heating a polyethylene glycol solution (PEG) and saccharide (sugar compounds) in a 500-W microwave oven for 2-10 minutes.

The functional groups containing oxygen, nitrogen, sulfide, and phosphorous are observed in the synthesis of carbon dots. These surface active groups enjoy the possibility of bonding with other groups such as oligonucleotide to join with DNA and mRNA which are of the capabilities of carbon quantum dots in biotechnology and nano-biotechnology applications. The use of cheap biocompatible materials like ethanol, citrate (citric acid salt), glucosamine, ascorbic acid, saccharide, candle soot, watermelon rind, shaddock rind, orange juice, strawberry juice, sugarcane extract, egg, chitosan, gelatin, lawn, tree leaves, agricultural wastes, and food wastes have also been developed for the production of green carbon quantum dots.

In general, different methods have been introduced for the production of carbon nanodots of which the following can be mentioned.

Li et al. (Xiaoming Li, Shengli Zhang, Sergei A. Kulinich, Yanli Liu & Haibo Zeng, Engineering surface states of carbon dots to achieve controllable luminescence for solid-luminescent composites and sensitive Be+2 detection, Scientific reports Nature, 2014.) used urea and citric acid to produce carbon dots. They placed a solution of water, urea, and citric acid for reaction in a hydrothermal reactor for 6 hours. Finally, they used centrifuge and dialysis membrane for the purification of the sample.

Also, Ruquan Ye et al. (Ruquan Ye, Changsheng Xiang1, Jian Lin, Zhiwei Peng, Kewei Huang, Zheng Yan, Nathan P. Cook, Errol L. G. Samuel, Chih-Chau Hwang, Gedeng Ruan, Gabriel Ceriotti, Abdul-Rahman O. Raji, Angel A. Marti & James M. Tour., Coal as an abundant source of graphene quantum dots, Nature Communication, 2013.) used coal as the precursor to produce graphene quantum dots. They placed a homogenous mixture of coal, sulfuric acid, and nitric acid in an oil bath under reflux conditions at 120° C. for 24 hours. The product was purified by filtration and dialysis membrane after neutralization with a 3-molar NaOH solution.

According to C. S. Stan et al. (C. S. Stan, C. Albu, A. Coroaba, M. Popa, D. Sutiman, One step synthesis of fluorescent carbon dots through pyrolysis of N-hydroxysuccinimide, Journal of Materials Chemistry C., 2012.) 3 grams of N-Hydroxysuccinimide was poured into a three-necked flask and placed on a stirrer heater; then, the temperature was raised up to the melting point of N-Hydroxysuccinimide to produce carbon dots. At this stage, the reaction was exposed to nitrogen atmosphere and temperature was raised up to 180° C. at a rate of 10 degrees per minute. At the end of the reaction 40 milliliters of deionized water was also added to the reaction and the final product was dried by freeze drying.

Yue Zhang and Junhui He (Yue Zhang and Junhui He, Facile synthesis of S, N co-doped carbon dots and investigation of their photoluminescence properties, journal of Phys. Chem. Chem. Phys, 2015.) also added 3 millimoles of cysteine and 1 millimole of citric acid to 10 milliliters of deionized water and the mixture was transferred to a Teflon vessel and heated up to 200° C. at a rate of 5° C. to produce carbon dots. The hydrothermal case was kept at this temperature for 5 hours and the product was then centrifuged for 5 minutes.

So far carbon nanodots have been used for different applications like chemical sensors, biosensors, biological imaging, nanomedicine, photocatalysts, and electrical catalysts. Of their applications one can refer to the detection of H₂O₂, Ag⁺, and Fe³⁺ ions (W. Zhu, J. Zhang, Z. Jiang, W. Wang and X. Liu, High-quality carbon dots: synthesis, peroxidaselike activity and their application in the detection of H₂O₂, Ag⁺ and Fe³⁺, RSC Adv., 4, 17387-17392, 2014.); detection of toxic ion of Hg²⁺ (W. Lu, X. Qin, A. M. Asiri, A. O. Al-Youbi and X. Sun, Green synthesis of carbon nanodots as an effective fluorescent probe for sensitive and selective detection of mercury(II) ions, J Nanopart Res., 15, 1344, 2013.); biological imaging (J. Wang, F. Peng, Y. Lu, Y. Zhong, S. Wang, M. Xu, X. Ji, Y. Su, L. Liao and Y. He, Large-scale green synthesis of fluorescent carbon nanodots and their use in optics applications, Adv. Optical Mater., 3, 103-111, 2015., Q. Liang, W. Ma, Y. Shi, Z. Li AND X. Yang, Easy synthesis of highly fluorescent carbon quantum dots from gelatin and their luminescent properties and applications, Carbon, 60, 421-428, 2013.), and cell imaging (L. Wang and H. S. Zhou, Green synthesis of luminescent nitrogen-doped carbon dots from milk and its imaging application, Anal. Chem., 86, 8902-8905, 2014.).

Industry always needs stable thermal nanofluids with the capability of required heat transfer (thermal conductivity and convection). The use of nanoparticles with high concentrations and also the use of chemical surfactants with high concentrations for the purpose of stabilization result in adverse effects on the performance of nanofluids, damaging the mechanical systems, and on the other hand, they relatively increase the cost which is not economical.

The purpose of the present invention is to introduce an economical and environmentally friendly nanofluid in addition to enjoying suitable stability and capability of heat transfer required by industry. This goal is realized by the production of nanofluids containing carbon dots with particle sizes of 0.5 to 10 nm and low concentration, since the amount of carbon nanostructures used in nanofluids is very low.

Additionally, the production costs of carbon nanoparticles (carbon dots) are very low and these materials are affordable through very simple methods with cheap precursors. Also, the nanomaterials employed do not create corrosion in the system. On the other hand, the carbon dots are biodegradable and can be obtained from non-toxic biodegradable resources.

### SUMMARY OF THE INVENTION

The present invention provides the formulation of nanofluids including carbon dot nanoparticles with particle sizes of 10 nm or less and base fluid.

In the present invention, the carbon dots are preferably present in the base fluid in a size of from 0.5 to 10 nm, more preferably 0.5 to <10 nm, more preferably 0.5 to 5 nm and most preferred 1 to 5 nm. In particularly preferred embodiments of the invention, the carbon dots have a size of at most 9 nm, more preferably at most 8 nm, more preferred at most 7 nm, more preferred at most 6 nm, even more preferred at most 5 nm, even more preferred at most 4 nm, even more preferred at most 3 nm, even more preferred at most 2 nm, even more preferred at most 1 nm.

In the present patent application, the carbon dot nanoparticles means one or any combination of carbon quantum dots, graphene quantum dots, graphene nanodots, graphene oxide nanodots, carbon nanotubes dots, and carbon nanostructures whose specifications are consistent with those cited in the invention background section in detail. Particularly preferred carbon dot nanoparticles are selected from the group consisting of carbon quantum dots, graphene quantum dots, graphene nanodots, graphene oxide nanodots, carbon nanotubes dots and combinations thereof with the specifications cited in the invention background section in detail.

In the present invention, nanofluids are produced through mixing nanoparticles of carbon dots with a particle size of 10 nm or less with the base fluid. Carbon dots are prepared by conventional, chemical, and physical methods. The chemical methods include electrochemical methods, combustion, hydrothermal, oxidation at high acid concentrations, microwave, ultrasonic, thermal reflux, and fission or degradation of carbon nanostructures such as fullerene, graphene, carbon nanotubes, etc. Physical methods consist of plasma method, electric arch discharge, laser ablation, etc. Compared to chemical methods, physical methods have more complex synthesis stages and their efficiency is lower relative to chemical methods. Therefore, chemical processes are more efficient, faster, and economically more justifiable on a large scale. Thus, chemical methods are preferred according to the present invention. Carbon dots in chemical methods are synthesized from different carbon precursors such as multi-walled carbon nanotubes, single-walled carbon nanotubes, double-walled carbon nanotubes, graphene, graphene oxide, fullerene, carbon nanofibers, activated carbon, carbon black, organic acids such as citric acid, saccharide such as sucrose glucose and natural precursors like tree leaves, soya bean, marc, fruit juice, fruit rind, sugarcane extract, egg, chitosan, gelatin, etc.

According to embodiments of the present invention, by the use of ammonium hydrogen citrate (C₆H₁₄N₂O₇) both as the precursor for carbon matter and as the nitrogen matter, carbon dots are synthesized by three methods of hydrothermal, microwave, and thermal reflux.

Preferably, the method of production of carbon dots comprises the steps of
a) Dissolving ammonium hydrogen citrate in a solvent,
b) Heating the obtained suspension to a temperature of 160-220° C.,
c) Keeping the suspension at a temperature of 160-220° C. for at time of 5 min to 24 hours,
d) Removing the solvent for obtaining the carbon dots.

A preferred solvent is water.

According to embodiments of the present invention, in hydrothermal method, a specific amount of ammonium hydrogen citrate is dissolved in water in a manner that the solution color is fully clear. Then, the solution is transferred to a hydrothermal teflon vessel and kept for 4-24 hours within the temperature range of 160-220° C. After the passage of a specific time, the hydrothermal vessel is cooled up to ambient temperature. Change of the solution to light yellow color shows the formation of carbon quantum dots. Then, the solvent is evaporated by the use of an evaporator.

According to embodiments of the present invention, the thermal reflux is used for the synthesis of carbon quantum dots. According to this method, the initial precursor (ammonium hydrogen citrate) is completely dissolved in water and by the use of a condenser and a three-necked flask the reaction is performed under air. The reaction temperature is controlled at a rate of 1-20 degrees centigrade per minute within the range of 160-220° C. Over time, the solution turns from colorless to light yellow showing the formation of carbon quantum dots. After that, the solution is cooled up to ambient temperature. Ultimately, the solution obtained is transferred to the evaporator and after full vaporization of the solvent, the product is collected and fully dried in a vacuum oven.

According to embodiments of the present invention, in the microwave method, a specific amount of ammonium hydrogen citrate is well dissolved in water and then the suspension is exposed to microwaves within the temperature range of 160-220° C. After the end of the reaction time, the dry product is cooled up to ambient temperature and collected from the reactor.

With regard to different methods (i.e. hydrothermal, thermal reflux, and microwave), the reaction time in the present invention can preferably vary from 5 min to 24 hr; for hydrothermal method more preferably from 8 hr to 24 hr, more preferably from 10 hr to 15 hr, more preferably 12 hr; for thermal reflux method more preferably from 1 hr to 6 hr, more preferably from 2 hr to 4 hr, more preferably 3 hr; and for microwave method more preferably from 2 min to 10 min, more preferably from 4 min to 6 min, more preferably 5 min. In the present invention, the carbon dots are preferably added to the base fluid in an amount of 0.0001-0.1% by weight of nanofluid, more preferably in an amount of 0.001-0.01% by weight of nanofluid. In preferred embodiments, the nanofluid composition of the present invention comprises carbon dots in an amount of <0.1% by weight of nanofluid, more preferably at most 0.05% by weight of nanofluid, more preferably at most 0.02% by weight of nanofluid, more preferably at most 0.01% by weight of nanofluid. The mixing of carbon dots and the fluid can be done by any device capable of mixing, like ultrasonic and stirrer. According to one embodiment of the present invention, the mixing is done by an ultrasonic for 5-30 minutes. The base fluid in this invention can preferably be water, alkylene glycols (ethylene glycol or diethylene glycol and combinations thereof), a mixture of water and alkylene glycol, and oil compounds like silicon oil, engine oil, etc.

Preferably, the nanofluid composition of the present invention has a pH of from 4 to 7, more preferably from 5 to 6, more preferably from 5.1 to 5.7, more preferably from 5.2 to 5.6.

In the present invention, chemical or non-chemical surfactants with low concentration can preferably be used for the production of oil-based nanofluids like nano-lubricants. Since in this invention carbon dot nanoparticles with very low concentration are used, therefore if there is a need for a surfactant, its concentration will also be low in the nanofluid and produces no significant change in the properties of the base fluid and no other problems will take place in the use of surfactants.

According to one embodiment of the present invention, if a surfactant is used for the production of the oil-based nanofluid, the ratio of the surfactant to the nanoparticles in nanofluid is preferably from 1:10 to 2:1, more preferably from 1:5 to 2:1, more preferably from 1:2 to 1:1, even more preferably about 1:1. High surfactant contents can lead to undesirable phenomena like corrosion and foaming, which negatively influence the properties of the nanofluid. Hence, the ratio of the surfactant to the nanoparticles in nanofluid is preferably at most 2:1.

If the synthesized carbon dots are in the form of a solution like the product obtained from hydrothermal method, the solution can be directly added to the based fluid with the desired concentration or it can be dried and be mixed with the fluid in due time and/or in other place. In this case, drying can be done by different methods like drying in an oven, in a vacuum oven, or by freeze drying.

Of the factors effective in the properties of nanofluids, one can consider the nanoparticles concentration as a very important factor, since properties like viscosity, density, pH, heat capacity, thermal conductivity coefficient, convective heat transfer coefficient, and stability of nanofluids all are directly affected by the concentration of nanoparticles. Although it is mentioned in different research papers that by an increase in the concentration of nanoparticles, generally the capability of heat transfer of nanofluids increases, it should be considered that an increase in concentration results in a change in the initial specifications like viscosity, density, and pH of the base fluid that can have adverse effects on the performance of the mechanical system leading to an increase in energy consumption. It has also been specified that an increase in the concentration of nanoparticles results in more instability of the nanofluid leading to the precipitation of particles on mechanical surfaces bringing about failure in mechanical systems. On the other hand, it should be noted that an increase in the concentration of nanoparticles leads to an increase in the cost of the production and industrial application of nanofluids. Generally, nanoparticles with a concentration of 0.1 to 10 wt % are used in research work to produce different nanofluids and in case their production is extended to industrial applications, we need several hundred kilograms of nanomaterials, but with regard to rather high costs of the production of nanomaterials it is not economical. It is therefore required to reduce the costs of production to a minimum so as to have attractions for the industrial applications of nanofluids; one of the solutions is the use of nanofluids with low concentrations (less than 200 ppm) for the production of nanofluids with optimal heat transfer capability. Also, the use of low concentrations does not change the rheological properties of the base fluid and in some cases it also improves their properties.

It should also be noted that both thermal conductivity and convective heat transfer are of the important properties of heat transfer in nanofluids. Therefore, to properly judge the performance of heat transfer in nanofluids, it is required to study their convective heat transfer behavior, in addition to their thermal conductivity.

Thermogravimetric analysis under air atmosphere is used to study the thermal stability and the rate of purity of carbon dots in the present invention.

Thermal conductivity of the synthesized nanofluid based on the present invention method is measured by hot wire method (KD2 Labcell Ltd UK) and its stability is measured by Zetta Potential. The nanofluid produced by the method presented in this invention is applicable to all the processes requiring stable thermal transfer fluid, or stable fluid.

The nanofluid of the present invention has different applications such as in various industrial systems including heating and cooling systems like heat exchangers, reactors, and cooling towers, rheological fluids, drilling fluids, and biological fluids. Due to the biodegradable properties of CQDs, they can also be utilized as an efficient nano agent for drug and gene delivery.

### BRIEF DESCRIPTION OF THE DRAWINGS

FIG. 1 is a chemical structure of carbon nanodots.

FIG. 2 is an X-ray diffraction (XRD) pattern of carbon quantum dots.

FIG. 3 is infra-red spectra of carbon quantum dots and ammonium hydrogen citrate.

FIG. 4 is a thermogravimetric (TGA) curve of carbon quantum dots.

FIG. 5 shows the particle size distribution of carbon quantum dots.

FIG. 6 is a transmission electron microscopy (TEM) image of carbon quantum dots.

FIG. 7 is a ultraviolet-visible (UV-Vis) absorption spectrum curve of carbon quantum dots.

FIG. 8 is a photoluminescence spectrum curve of carbon quantum dots.

FIG. 9 is a zeta potential (z-potential) curve of the suspension containing 200 ppm of carbon quantum dots with the average particle size of 1 nm.

FIG. 10 shows the trend of changes of convective heat transfer coefficient (h) relative to the concentration of the nanoparticles in different Reynolds numbers.

FIG. 11 is a water evaporation rate chart.

FIG. 12 shows the particle size distribution of carbon quantum dots with the size of 10 nm.

FIG. 13 is a transmission electron microscopy image of carbon quantum dots with the size of 10 nm.

FIG. 14 is a z-potential curve of the suspension containing 200 ppm of carbon quantum dots with the size of 10 nm.

FIG. 15 is an X-ray diffraction (XRD) pattern of graphene quantum dots.

FIG. 16 is a Fourier transform infrared spectroscopy (FTIR) image of graphene quantum dots.

FIG. 17 is a UV-Vis absorption spectrum curve of graphene quantum dots.

FIG. 18 is a photoluminescence spectrum curve of graphene quantum dots.

FIG. 19 shows the particle size distribution of graphene quantum dots.

FIG. 20 is a TEM image of graphene quantum dots.

FIG. 21 is a z-potential curve of the suspension containing 200 ppm of graphene quantum dots with the size of 1 nm.

FIG. 22 shows the particle size distribution of graphene quantum dots with the size of 10 nm.

FIG. 23 is a TEM image of graphene quantum dots with the size of 10 nm.

FIG. 24 is a z-potential curve of the suspension containing 200 ppm of graphene quantum dots with the size of 10 nm.

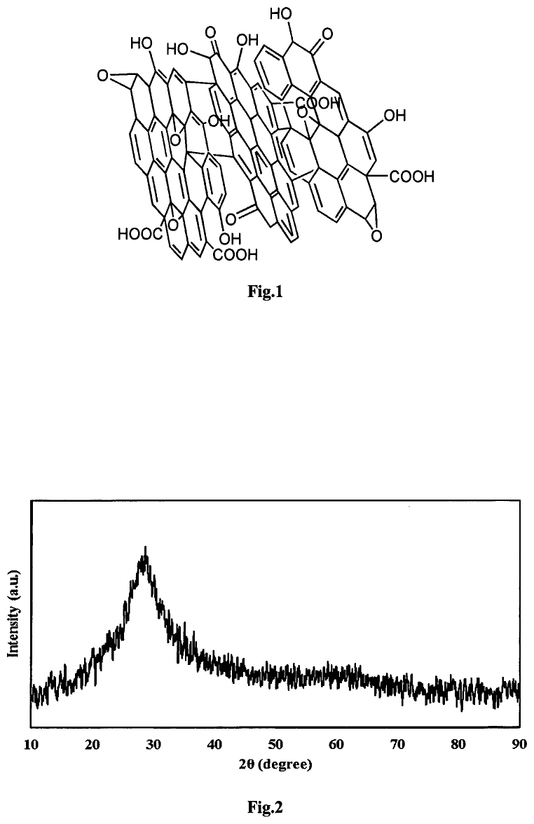

The examples below are given for elaborating the subject-matter of the present invention and the invention is not limited to them.

### EXAMPLE 1: PRODUCTION OF CARBON DOTS BY HYDROTHERMAL METHOD

An amount of 1-5 grams of ammonium hydrogen citrate was dissolved in 10-20 grams of deionized water to obtain a clear solution. Then, the solution was transferred to a hydrothermal teflon vessel and kept within the temperature range of 160-220° C. for 8-24 hours. Ultimately, the solvent was evaporated by the use of a rotary evaporator. For every 2 grams of the initial precursor, less than 0.9 gram of carbon quantum dot was obtained in this method.

### EXAMPLE 2: PRODUCTION OF QUANTUM DOTS BY THERMAL REFLUX METHOD

In this method, 1-5 grams of the initial precursor (ammonium hydrogen citrate) was fully dissolved in 10-20 grams of deionized water and was exposed to air flow by the use of a condenser and a three-necked flask. The reaction temperature was controlled at a rate of 15° C./min within the range of 160-220° C. With the passage of time, the solution turned from colorless to light yellow showing the formation of carbon quantum dots. Then, the solution was cooled up to the ambient temperature. Ultimately, the obtained solution was transferred to the rotary evaporator and after full evaporation of the solvent, the product was collected and fully dried in a vacuum oven. For every 2 grams of the initial precursor, about 1 gram of carbon quantum dot (CQD) was obtained.

### EXAMPLE 3: PRODUCTION OF CARBON QUANTUM DOTS BY MICROWAVE METHOD

According to one embodiment of the present invention, 1-5 grams of the initial precursor (ammonium hydrogen citrate) was fully dissolved in 10-20 grams of deionized water and then the suspension was exposed to microwave within the temperature range of 160-220° C. After the completion of the reaction time, the dried product was cooled up to the ambient temperature and then collected from the reaction vessel. The yield of this method was better than the hydrothermal method and for every 2 grams of the initial precursor, about 1.65 grams of carbon quantum dot was obtained. As it is observed, the highest yield pertains to the microwave method. The yield of hydrothermal and thermal reflux methods is almost close to each other and with regard to the simplicity of thermal reflux and very short reaction time, the thermal reflux method is of higher priority relative to hydrothermal method. On the whole, the microwave method is more desirable for production at a low scale with regard to its higher yield among the three methods. Therefore, regarding this fact, we embark on the determination of physical specifications of synthesized carbon quantum dots by microwave method in continuation.

In the analysis of X-ray diffraction pattern of synthesized carbon quantum dots, as expected, it can be pointed to their amorphous nature and of course to their very low crystallinity. As it is specified in FIG. 2, the peak appearing at 15-350 with a distance between the sheets of about 3.77 Å which is greater than the distance between sheets (002) for the bulk graphite can be related to a turbostratic carbon structure. Based on the previous reports, carbon dots mostly contain sp² carbons in which the distance between the layers are compatible with graphite carbon or turbostratic form.

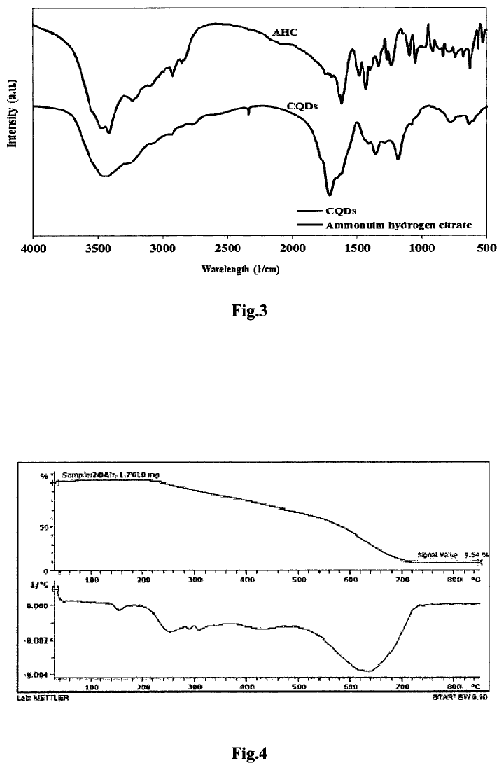

The infrared spectrum of the synthesized carbon quantum dots is a completely different pattern from what has been shown for the bulk graphite or other merely carbon structures. With regard to the presence of nitrogen heteroatoms and oxygen in the structure of carbon quantum dots, the absorptions associated with tensile and bending vibrations special for the bonds formed between carbon and these heteroatoms are predictable. With regard to FIG. 3, the absorption band of 1730 cm⁻¹ region is related to C═O tensile vibration. Wide absorption in 2700-3600 cm′ region is due to the presence of O—H groups related to HO—C═O or C—OH, of course, it seems that the N—H tensile absorption has also been overlapped in this region. Specification absorption of C—O has also appeared in 1192 cm⁻¹ region which is also true for tensile C—N. Tensile absorptions related to tensile C═C and N—H bending are also observed in 1635-1680 cm⁻¹ region.

Thermogravimetric analysis was used under air atmosphere to study the thermal stability and the rate of the purity of carbon quantum dots. According to FIG. 4, thermogravimetric analysis performed for synthesized carbon quantum dots in general has two main stages of weight loss. In the first stage up to a temperature of about 250° C., no weight loss is observed, and up to 600° C. 50 percent weight loss is observed showing relatively suitable stability of carbon quantum dots with regard to the desired application as a nanofluid. Ultimately, at temperatures ranging from 600 to 800° C., about 90% weight loss is observed by losing water and also loss of functional groups. The impurity rate is about 10% with regard to the TGA curve.

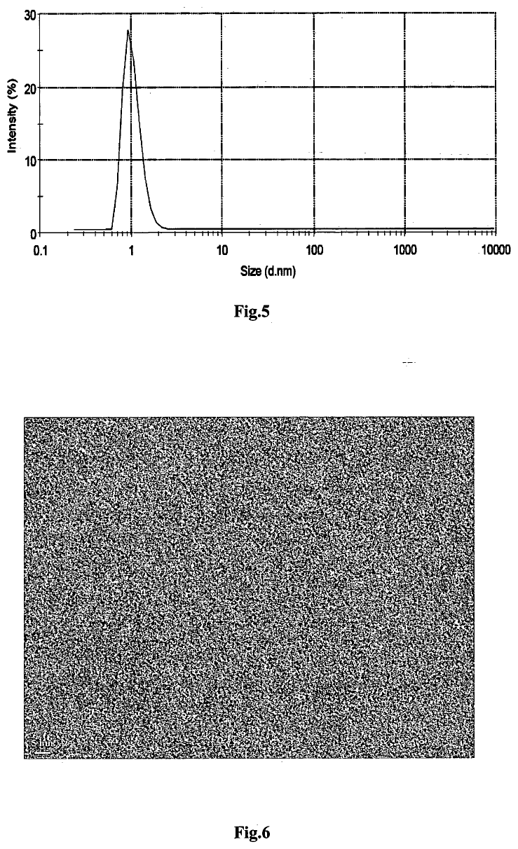

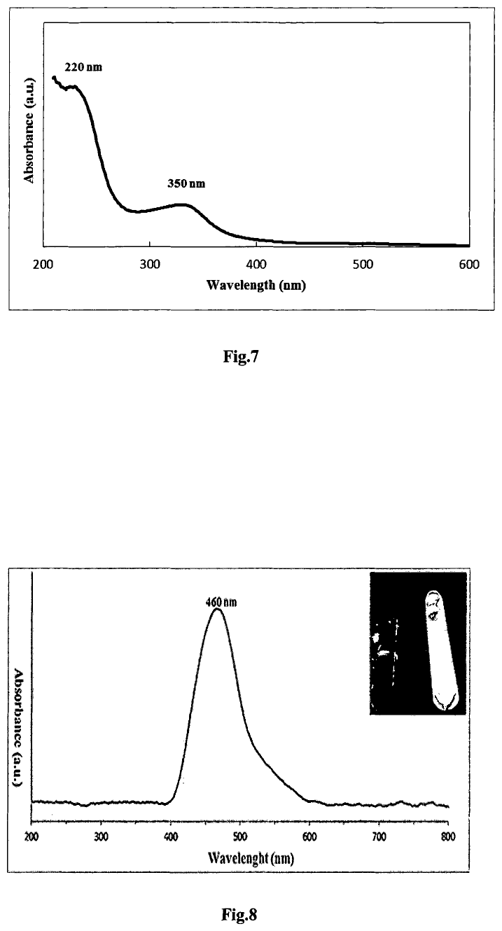

FIG. 5 shows the distribution of the size of particles on the basis of dynamic light scattering (DLS). As it is observed, the size of carbon quantum dots based on hydrodynamic radius of the particles is about 1 nm and the TEM image (FIG. 6) clearly confirms it. The TEM image in FIG. 6 clearly explains the synthesis of carbon quantum dots with an average size of particles ranging from 0.5 to 3 nm confirming the results obtained from DLS analysis. FIG. 7 is related to the study of UV-Vis spectrum of the nanofluid made from carbon quantum dots. As it is specified in FIG. 8, the broad peak at the wavelength of 220 nm is related to the transfer of electron in π-π* transition state of C═C bond. Also, the specified peak at the wavelength of 350 nm is related to the electron transfer of n-π* transition state of C═C and C═N bonds. The wavelength of 360 nm is the excitation limit of the carbon quantum dots. FIG. 7 is the spectrum related to the emission wavelength of carbon quantum dots under the excitation wavelength of 360 nm. As it is specified in this figure, the emission wavelength is about 460 nm located within the blue spectrum. The image specified on the right shows the florescent property of carbon quantum dots compared with solvent (deionized water) under UV lamp with a wavelength of 365 nm that clearly shows emission within the blue spectrum.

### EXAMPLE 4: PREPARATION OF NANOFLUID

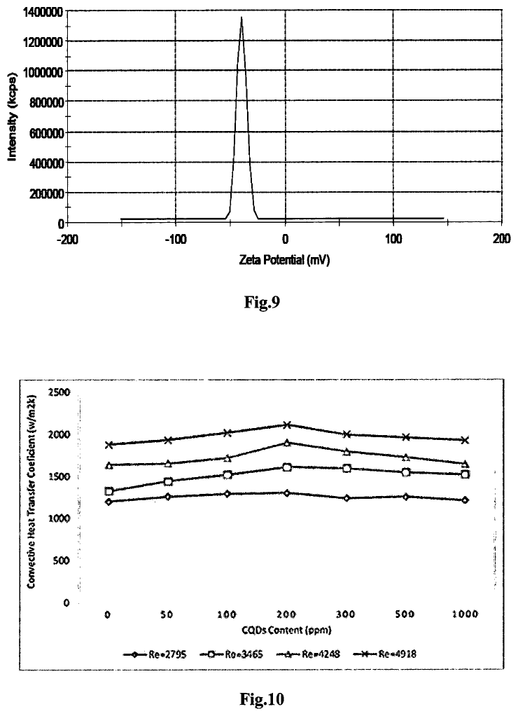

The carbon nanoparticles quantum dots obtained from example 3 were used to prepare nanofluid samples. 0.005-0.1 percent by weight of nanofluids, the carbon quantum dots was added to the base fluid (water or ethyl glycol (ex. 6 and 10)) and the container of the sample was placed in an ultrasonic bath at room temperature (25° C.) with a frequency of 37 kHz for only 15 minutes to stabilize the nanoparticles and no chemical surfactant and/or other additives were used for the preparation of the samples. Furthermore, in order to study the stability of nanoparticles in water, the z-potential test was used. As it is observed in FIG. 9, the zeta value is about −38.8 my representing its very high stability rate. Also, the negative values of zeta potential display the formation of amine groups which contribute to suspension stability. The nanofluids prepared by this method enjoy a very high stability and at least no precipitation and change of state have been observed for 6 months.

The simplicity of the production method, very excellent stability, and no use of chemical surfactants are of the advantages of the nanofluids produced in this invention.

### EXAMPLE 5: STUDY OF THE EFFECT OF CQD NANOPARTICLES ON NANOFLUID PROPERTIES

In general, the thermal fluid selected as the base fluid for the preparation of nanofluids enjoys some innate characteristics which are very effective and favorable in its performance. Therefore, the effect resulting from the addition of carbon nanodots on the pH, viscosity, and water boiling point as the properties of the base fluid was studied. To study the effect of the concentration of CQD nanoparticle, the samples were prepared in different concentrations on the basis of the method described in example 4 (Table 1). Then, the value of pH of the samples was measured in three repetitions by CRISON pH-meter BASIC +20. pH is considered as an important parameter in the stability of nanofluid and also improvement of thermal conductivity coefficient. The results show that the pH value of the samples, especially with 200 ppm concentration of CQD has not changed so much compared with the base fluid.

TABLE 1
The effect of CQDs on pH, viscosity and boiling
point of heat transfer nano fluids

| Concentration | | | | |
|---|---|---|---|---|
| of CQDs | Weight | | Viscosity | Boiling Point |
| (ppm) | (wt %) | pH | (cSt at 40° C.) | (° C.) |
| 0 (base fluid) | 0 | 5.85 | 0.6760 | 88 |
| 200 | 0.02 | 5.54 | 0.6802 | 89.5 |
| 500 | 0.05 | 5.28 | 0.6860 | 92 |
| 1000 | 0.1 | 5.0 | 0.6873 | 94 |

Then, the viscosity value of the samples was measured on the basis of ASTM D445-12 standard. According to the results, no noticeable change was also observed in the viscosity of the nanofluids compared with the base fluid. Furthermore, the boiling point of the samples containing CQD nanoparticles slightly increased compared to that of the base fluid that can be considered as a positive effect for a thermal fluid.

### EXAMPLE 6: THE EFFECT OF THE CQD NANOPARTICLES ON THERMAL CONDUCTIVITY COEFFICIENT OF NANOFLUIDS

In order to study the effect of carbon quantum dots on thermal conductivity coefficient (K) of the base fluid, thermal conductivity of the prepared nanofluids was measured by KD2 Labcell Ltd UK at room temperature (25° C.). In this example, ethylene glycol was used as the base fluid for the preparation of nanofluid and its thermal conductivity coefficient was measured at room temperature (0.238 w/mk). According to Table 2, the effect of the concentration of nanoparticles was studied as an important factor in industrial application. The nanofluid samples were prepared in different concentrations of 0.01-0.1 wt %. The results suggested an improvement in K at a rate of 2.9-10 percent compared with the base fluid. As it is explicitly stated, by an increase in concentration up to 500 ppm, the thermal conductivity coefficient experiences an upward trend, but after that it starts to slow down due to the agglomeration of CQD nanoparticles along with an increase in concentration. Due to the importance of concentration parameter in the preparation of nanofluids, Z factor is defined as the ratio of improvement percentage of thermal conductivity coefficient (L) to weight percentage of concentration (Z=L/wt %) to determine the optimal concentration. The results obtained from the Z parameter suggest that the highest rate of an increase in thermal conductivity coefficient relative to the concentration of CQD nanoparticles is obtained in 200 ppm concentration which can be suitable for industrial applications from the point of economic costs and stability of nanofluid.

TABLE 2
The effect of CQDs concentration on
thermal conductivity of nano fluids

| Concentration | | Thermal | | | |
|---|---|---|---|---|---|
| of CQDs | Weight | Conductivity | Average | L | Z |
| (ppm) | (wt %) | (W/mK) | (W/mK) | (%) | (L/wt %) |
| 0 | 0 | 0.239 | 0.238 | — | — |
| | | 0.238 | | | |
| | | 0.238 | | | |
| 100 | 0.01 | 0.245 | 0.245 | 2.9 | 290 |
| | | 0.245 | | | |
| | | 0.245 | | | |
| 200 | 0.02 | 0.256 | 0.255 | 7.1 | 355 |
| | | 0.255 | | | |
| | | 0.255 | | | |
| 400 | 0.04 | 0.261 | 0.260 | 9.2 | 230 |
| | | 0.259 | | | |
| | | 0.260 | | | |
| 500 | 0.05 | 0.262 | 0.262 | 10.1 | 202 |
| | | 0.261 | | | |
| | | 0.262 | | | |
| 1000 | 0.1 | 0.257 | 0.258 | 8.4 | 84 |
| | | 0.258 | | | |
| | | 0.258 | | | |

### EXAMPLE 7: THE EFFECT OF CQD NANOPARTICLES ON THE CONVECTIVE HEAT TRANSFER COEFFICIENT OF NANOFLUIDS

Although thermal conductivity is of important properties of heat transfer, right judgment on the performance of heat transfer of nanofluids requires a study to be performed on their convective heat transfer behavior. With regard to the fact that the coefficient of convective heat transfer is a flow property, it also depends on Reynolds number of flow in addition to boundary conditions in a laboratory system (constant heat flux). The convective heat transfer coefficient (h) of nanofluid (water/CQDs) at ambient temperature and in different weight fractions and Reynolds numbers were examined in this example (Table 3). For this purpose, a laboratory system consisting of test section, pump, fluid storage, tube-shell exchanger, and circulator was used. The test section consists of a smooth copper tube with an internal diameter of 11.42 mm and a length of 1 m. The copper tube is covered with an element heated by an AC current and a ceramic insulator with a thickness of 150 mm preventing heat loss. The temperature of the tube surface and that of the inlet and outlet of the fluid are measured by the use of 5 thermocouples of K type and two other thermocouples, respectively. The flow rate is adjustable from 1.15 to 6 lit/min. The tube-shell exchanger and circulator are also used to cool the fluid. Ultimately, the convective heat transfer coefficient is calculated by the following equations:

$$h ( x ) = \frac{{q}^{″}}{{T}_{s} ( x ) - {T}_{m} ( x )}$$

$$q = {m}^{*} \cdot {C}_{p} ( {T}_{out} - {T}_{i n} )$$

Where Tₛ is the average temperature of the tube wall; Tₘ is the fluid temperature; Cₚ is the thermal capacity; m is the fluid mass flow rate; and Tₒᵤₜ and Tᵢₙ are the outlet and inlet of the fluid into the copper tube, respectively. Also, q″ is the constant thermal flux obtained by dividing q thermal flux by the area surrounding the copper tube. In general, the results show that the addition of CQD nanoparticles to water leads to an increase in the capability of convective heat transfer. By an increase in Reynolds number, the convective heat transfer coefficient always follows an upward trend (Table 3). The changes trend of h relative to the concentration of nanoparticles in different Reynolds numbers is shown in FIG. 10. As it is observed, the most rate of increase in convective heat transfer coefficient takes place in 200 ppm concentration. It should be noted that although it is generally expressed in research work that by an increase in the concentration of nanoparticles (more than 1 weight percent), the capacity of heat transfer also increases; regarding the nanoparticles of carbon quantum dots, it should be mentioned that due to the smallness of the particles (about 1 nm), the number of the particles in nanofluid volume unit is therefore very high leading to faster agglomeration process by a slight increase in the concentration of particles. Such physically and completely true and acceptable conclusion explains this fact that for a constant weight concentration, nanofluids with smaller particles have more contact surfaces leading to more exchange of heat between the nanoparticles and the liquid fluid.

TABLE 3
The effect of CQDs concentration on
Convective heat transfer coefficient

| Concentration | | | | | |
|---|---|---|---|---|---|
| of CQDs | Weight | h (W/m²K) | | | |
| (ppm) | (wt %) | Re = 2795 | Re = 3465 | Re = 4248 | Re = 4918 |
| 0 | 0 | 1202 | 1325 | 1637 | 1878 |
| 50 | 0.005 | 1259 | 1442 | 1654 | 1931 |
| 100 | 0.01 | 1290 | 1517 | 1716 | 2018 |
| 200 | 0.02 | 1302 | 1610 | 1899 | 2110 |
| 300 | 0.03 | 1238 | 1593 | 1789 | 1993 |
| 500 | 0.05 | 1255 | 1547 | 1722 | 1960 |
| 1000 | 0.1 | 1212 | 1519 | 1641 | 1925 |

Table 4 shows the nanofluid (200 ppm) heat transfer behavior in different Reynolds numbers. The most increase in value of h relative to the base fluid is the value of 21.5 percent in 3465 Reynolds.

TABLE 4
Convective heat transfer coefficient in 200 ppm concentration

| | h (W/m²K) | | Enhancement |
|---|---|---|---|
| Re | Pure water | Nano fluid | (%) |
| 2795 | 1202 | 1302 | 8.3 |
| 3465 | 1325 | 1610 | 21.5 |
| 4248 | 1637 | 1899 | 16 |
| 4918 | 1878 | 2110 | 12.3 |

### EXAMPLE 8: STUDY OF THE PERFORMANCE OF COOLING TOWERS BY THE USE OF WATER/CQD NANOFLUID

Power stations are considered as one of the most important industrial centers of countries with special sensitivity. Cooling systems are one of the important sections of power stations. Also, the importance of the role of water in different types of cooling systems such as cooling towers, chillers, heat exchangers, etc. is well-specified. Cooling towers are made of one structure with specific composition and shape in which hot water is naturally or mechanically cooled in contact with air. Hot water in cooling towers is directly or indirectly in contact with air flow and loses its heat to be used for subsequent uses. Normally, except for towers designed for specific uses, the fluid used in all cooling towers is water.

In order to study the effect of water/CQD on the performance of cooling towers, a lab tower with a height of 70 cm and a cross-section of 30*30 cm² containing packing of PVC was used. The water entering the tower was heated by an element and directed to the top of the tower by a pump. Air was flowed by a sucking fan at the top of the tower. A graduated make-up water vessel was used beside the tower to control the water level in the tower basin. To control water and air rate, a voltage control system was also used to change the fan and pump speed. By the use of four thermocouples of K type, the temperature of the inlet and outlet water and air was measured and registered.

One of the important parameters in studying cooling towers is the efficiency of the cooling tower (η) on which the performance of the tower in different states can be studied. The efficiency of the tower is calculated on the basis of the following equation. Where Tₒᵤₜ and Tᵢₙ are the outlet and inlet temperatures of the fluid of the tower, respectively and T_{b} is the moisture temperature.

$$η = \frac{{T}_{i n , water} - {T}_{out , water}}{{T}_{i n , water} - {T}_{b}}$$

Therefore, a definite volume of water/CQD nanofluid with a concentration of 0.05 wt % was prepared and poured into the tower basin. The nanofluid temperature was adjusted at 33° C. by the use of an element and water and air flow were established in the tower. Temperature changes were registered on the basis of the ratio of water to air (L/G). Table 5 shows the tower efficiency and the rate of temperature difference between the inlet and outlet water of the cooling tower at different ratios of L/G. As it is observed, the use of additive nanoparticles in water improves the efficiency of the tower. Also, the noticeable and important point is the effect of nanofluid on the difference between the temperature of the inlet and outlet water of the tower (ΔT) with the use of nanoparticles leading to an increase in temperature difference. This is one of the important benefits of the use of nanofluids in cooling towers bringing about a decline in energy consumption. Of course, by an increase in the ratio of L/G, the rate of ΔT is reduced since an increase in the water rate results in the reduction of retention time and/or in other words, reduction in contact time of water and air results in improper heat transfer because water does not lose its heat in full.

TABLE 5
Tower efficiency and the rate of temperature
difference between the inlet and outlet water

| | |
|---|---|
| Water | Water + CQD 0.05 wt % |

| L/G | TΔ (° C.) | η | TΔ (° C.) | η |
|---|---|---|---|---|
| 0.9 | 6.4 | 0.37 | 7.6 | 0.4 |
| 1.2 | 5 | 0.28 | 6.8 | 0.36 |
| 1.4 | 4.3 | 0.24 | 6.1 | 0.33 |

### EXAMPLE 9: STUDY OF THE EFFECT OF CQD NANOPARTICLES ON THE RATE OF THE WATER USED BY COOLING TOWERS

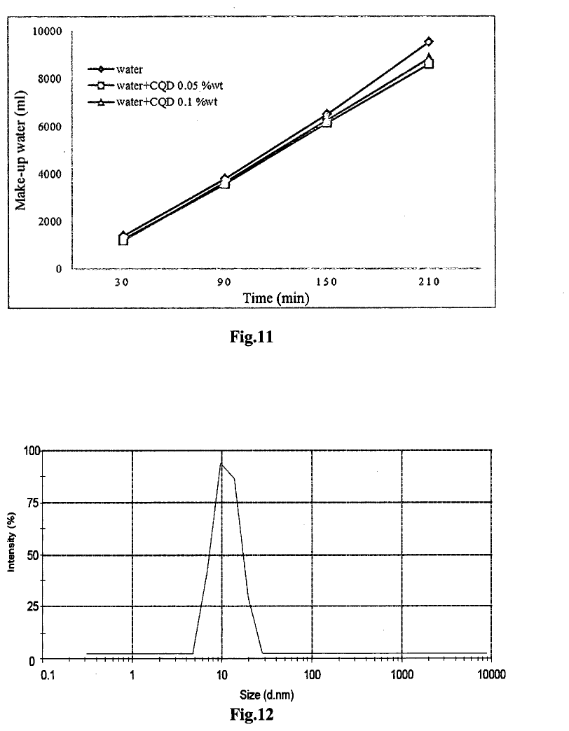

Since the rate of the water used through evaporation in cooling towers have a significant role in their efficiency, therefore definite volumes of water/CQD nanofluid with 0.05 wt % and 0.1 wt % concentrations were prepared and poured into the tower basin. The temperature of the nanofluid was adjusted by the use of an element at 33° C. and the flow of water and air was established inside the tower. Then, the rate of water evaporation was measured and registered on the basis of the volume of the make-up water at different periods of time (Table 6). FIG. 11 shows the rate of water evaporation with the passage of time. As it is specified, the use of nanoparticles as additives to water reduces the rate of evaporation and leads to water saving which is another advantage of the use of nanofluids in cooling systems. On the other hand, it is noteworthy that nanofluids with a concentration of 0.05 wt % have better performance relative to nanofluids with a concentration of 0.1 wt %.

TABLE 6
make-up water for the cooling tower in different times

| | Make-up water (ml) | | |
|---|---|---|---|
| Time | | Water + CQD | Water + CQD |
| (min) | water | 0.05 wt % | 0.1 wt % |
| 30 | 1400 | 1250 | 1200 |
| 90 | 3800 | 3580 | 3640 |
| 150 | 6500 | 6130 | 6250 |
| 210 | 9525 | 8600 | 8850 |

### EXAMPLE 10: STUDY OF THE SIZE EFFECT OF CARBON QUANTUM DOT NANOPARTICLES ON THE THERMAL CONDUCTIVITY

As it was mentioned before, the capability of heat transfer of nanofluids improves with a reduction in the size of nanoparticles. Two theoretical mechanisms, i.e. Brownian motion of particles and stratification of fluid around the particles support it, since the Brownian motion and specific surface of the particles are increased by the shrinkage of the size of the nanoparticles. To study the effect of the size of carbon quantum dots on the capability of thermal conductivity of nanoparticles and also to confirm the above theory, an experiment was performed.

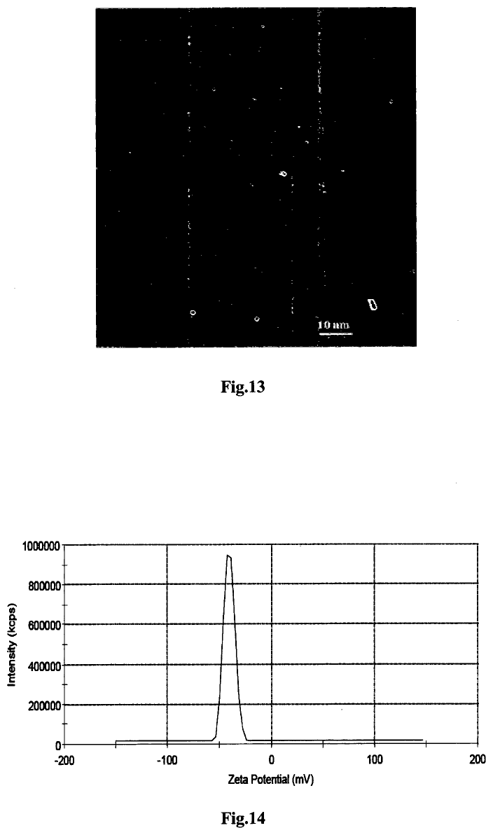

First, the CQD nanoparticles with a size of about 10 nm were separated by the use of column chromatography. FIGS. 12 and 13 show the particle size distribution of carbon quantum dots on the basis of dynamic light scattering and a transmission electron microscopy (TEM) image of carbon quantum dots with the size of 10 nm, respectively.

Then, the CQD/ethylene glycol nanofluid was prepared in three concentrations of 100, 200, and 400 ppm. The thermal conductivity coefficient (K) of the samples was measured at room temperature (25° C.) by the use of KD2 Labcell Ltd UK. The results are presented in Table 7 along with the results of example 6. Comparison of the results showed that by an increase in the size of CQD nanoparticles, the rate of improvement for the capability of thermal conductivity of nanofluid was slightly reduced and in fact the above theory regarding carbon nanodots was also confirmed.

TABLE 7
The effect of CQDs size on thermal conductivity of nano fluids

| | |
|---|---|
| Concentration | K (w/mk) |

| of CQDs | Weight | Size of CQDs | Size of CQDs |
|---|---|---|---|
| (ppm) | (wt %) | 1 nm | 10 nm |
| 0 | 0 | 0.238 | 0.238 |
| 100 | 0.01 | 0.245 | 0.241 |
| 200 | 0.02 | 0.255 | 0.252 |
| 400 | 0.04 | 0.260 | 0.256 |

### EXAMPLE 11: STUDY OF THE EFFECT OF THE SIZE OF CARBON QUANTUM DOT NANOPARTICLES ON THE CONVECTIVE HEAT TRANSFER COEFFICIENT

As it was mentioned before, the capability of heat transfer of nanofluids improves with a reduction in the size of nanoparticles. Two theoretical mechanisms, i.e. Brownian motion of particles and stratification of fluid around the particles support it, since the Brownian motion and specific surface of the particles are increased by the shrinkage of the size of the nanoparticles. The effect of the size of carbon quantum dots on the convective heat transfer was studied in this example.

First, the CQD nanoparticles with a size of about 10 nm were separated by the use of column chromatography. Then, the CQD/water nanofluid was prepared in three concentrations of 100, 200, and 300 ppm. The convective heat transfer coefficient was measured by the use of FIG. 3 setup in different Reynolds numbers (Table 8). The results showed that although the value of h in the prepared nanofluids increased relative to the base fluid compared with example 7, it was specified that an increase in the size of quantum carbon nanoparticles had an adverse effect on the rate of convective heat transfer coefficient of the nanofluid. Table 9 demonstrates the comparison of convective heat transfer coefficient changes of the prepared nanofluids with those of 1 and 10 nm nanoparticles in 200 ppm concentration. As it is observed, an 10-time increase in the size of the nanoparticles of CQDs brings about 2.3 percent reduction in the average increase of h relative to the base fluid.

In order to study the stability of nanoparticles with a size of 10 nm in water, the z-potential test was used. As it is observed in FIG. 14, the zeta value is about −37.3 my representing its very high stability rate. Also, the negative values of zeta potential display the formation of amine groups which contribute to suspension stability.

TABLE 8
The effect of CQDs concentration on
convective heat transfer coefficient

| Concentration | | | | | |
|---|---|---|---|---|---|
| of CQDs | Weight | h (W/m²K) | | | |
| (ppm) | (wt %) | Re = 2795 | Re = 3465 | Re = 4248 | Re = 4918 |
| 0 | 0 | 1202 | 1325 | 1637 | 1878 |
| 100 | 0.01 | 1274 | 1480 | 1692 | 2003 |
| 200 | 0.02 | 1288 | 1579 | 1845 | 2069 |
| 300 | 0.03 | 1235 | 1554 | 1780 | 1954 |

TABLE 9
Comparison the effect of CQDs size on convective heat transfer coefficient

| Average size | Concentration | | | | | Average of |
|---|---|---|---|---|---|---|
| of CQDs | of CQDs | h (W/m²K) | | | | increase than |
| (nm) | (ppm) | Re = 2795 | Re = 3465 | Re = 4248 | Re = 4918 | base fluid (%) |
| 1 | 200 | 1302 | 1610 | 1899 | 2110 | 14.5 |
| 10 | 200 | 1288 | 1579 | 1845 | 2069 | 12.2 |

### EXAMPLE 12: SYNTHESIS OF GRAPHENE QUANTUM DOT NANOPARTICLES

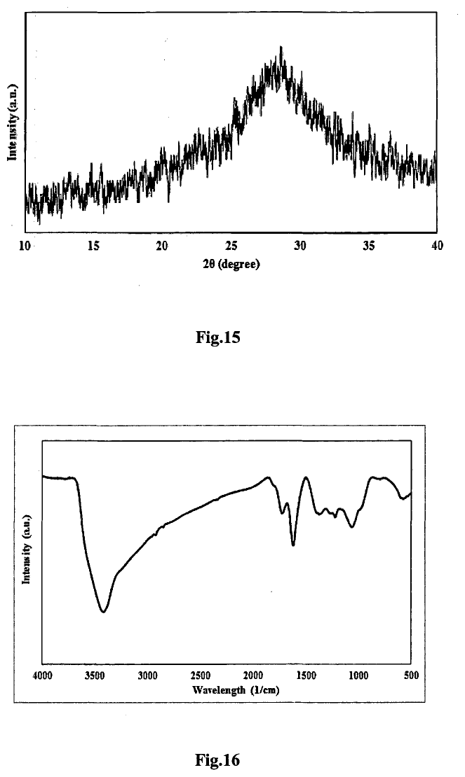

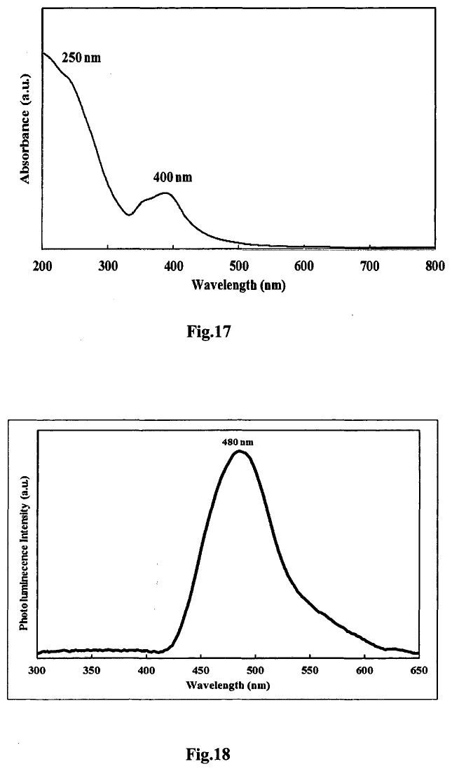

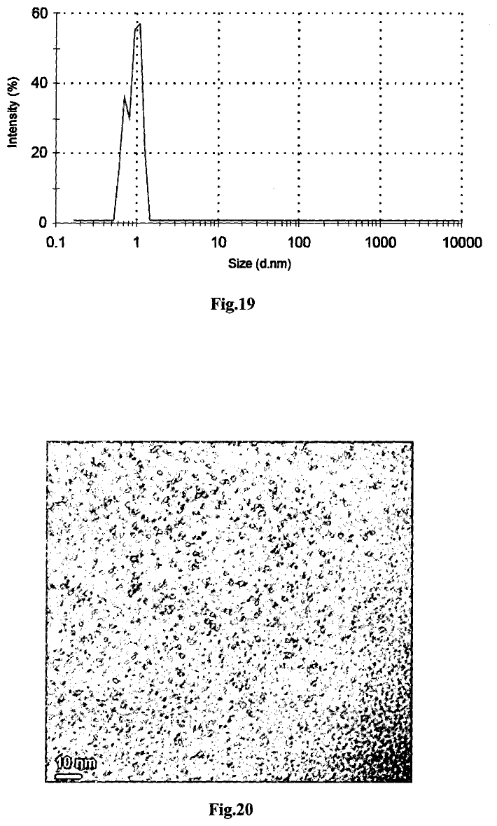

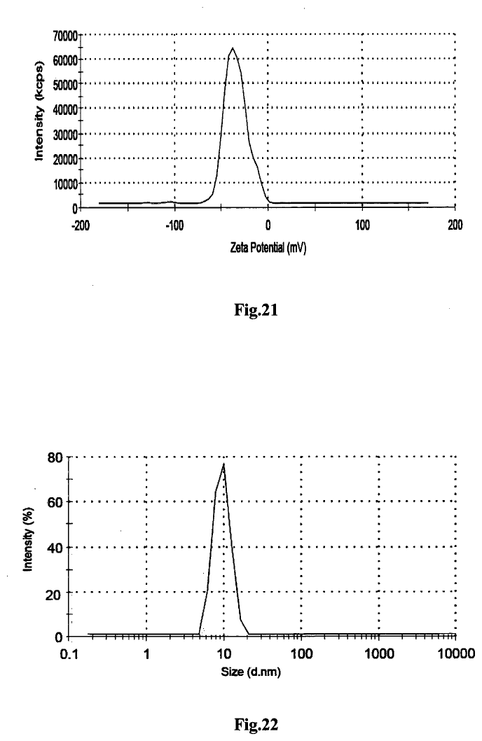

In order to synthesis graphene quantum dots, 1-5 grams of activated carbon was placed in 150-800 ml of concentrated nitric acid for 12-24 hours under 80-100° C. heat reflux conditions. After cooling up to room temperature, the excess acid was removed from the suspension by washing with 1-5 liters of deionized water and using a 0.22-micrometer membrane. The product was then well dispersed in 200-1000 ml of 0.5-molar sodium hydroxide solution and transferred to hydrothermal teflon vessel. The hydrothermal vessel was kept at 200° C. for 15-10 hours. After cooling up to ambient temperature, the product was separated by a 0.22-micron membrane and purified for 2-3 days with a 3500-Dalton dialysis membrane. Ultimately, the product was dried at 70-80° C. and chromatography column was used for the separation of finer dots. The XRD spectrum related to quantum dots is shown in FIG. 15. As it is specified in this figure, the broad peak within the range of 29 degrees is related to carbon 002-crystalline sheets with a distance of 3.34 Å between the sheets. FIG. 16 shows the FTIR spectrum of quantum dots. The peak related to C═C, C—O, and O—H bonds is clearly observed in 1600 cm⁻¹, 1280, and 3450 regions, respectively. FIG. 17 shows the UV-Vis spectrum related to the sample of graphene quantum dots where the specific peak in 250 nm region is related to C═C bonds in π-π* transition state; while the specific peak in 400 nm region is related to the electron transfer in C═O bonds. FIG. 18 shows the spectrum of the emission of graphene quantum dots with an excitation wavelength of 365 nm and an emission wavelength of about 480 nm which is a little more than that of the carbon quantum dots. However, the emission wavelength of graphene quantum dots is also within the blue range. FIG. 19 shows the DLS analysis of graphene quantum dots with the dominant 1 nm size which is in good conformity with the electron microscope images. FIG. 20 shows the TEM image of these dots. FIG. 21 shows the stability analysis of graphene quantum dots (Zeta potential test) with the index peak within the range of −40 my denoting the high stability of these dots.

### EXAMPLE 13: THE EFFECT OF GRAPHENE QUANTUM DOT NANOPARTICLES ON THERMAL CONDUCTIVITY COEFFICIENT OF NANOFLUIDS

In order to study the effect of graphene quantum dots on thermal conductivity coefficient (K) of the base fluid, the thermal conductivity of nanofluids was measured by the use of Kd2 Labcell Ltd UK at room temperature (25° C.). The intended nanofluid was prepared according to example 4, based on distilled water.

As it is shown in Table 10, the effect of the concentration of graphene quantum dot nanoparticles as an important factor in industrial applications has been investigated. The results are indicative of an improvement of K at a rate of 3-10.3 percent relative to the base fluid.

TABLE 10
The effect of GQDs concentration on
thermal conductivity of nano fluids

| | | | Average of |
|---|---|---|---|
| Concentration | | Thermal | Thermal |
| of GQDs | Weight | Conductivity | Conductivity |
| (ppm) | (wt %) | (W/mK) | (W/mK) |
| 0 | 0 | 0.562 | 0.560 |
| | | 0.561 | |
| | | 0.557 | |
| 100 | 0.01 | 0.575 | 0.577 |
| | | 0.578 | |
| | | 0.577 | |
| 200 | 0.02 | 0.592 | 0.593 |
| | | 0.592 | |
| | | 0.594 | |
| 400 | 0.04 | 0.609 | 0.611 |
| | | 0.612 | |
| | | 0.613 | |
| 500 | 0.05 | 0.617 | 0.618 |
| | | 0.618 | |
| | | 0.618 | |
| 1000 | 0.1 | 0.614 | 0.614 |
| | | 0.613 | |
| | | 0.615 | |

### EXAMPLE 14: THE EFFECT OF GRAPHENE QUANTUM DOT NANOPARTICLES ON CONVECTIVE HEAT TRANSFER COEFFICIENT OF NANOFLUIDS

In order to study the performance of heat transfer of nanofluids containing graphene quantum dot nanoparticles, convective heat transfer coefficient (h) of GQDs/water nanofluid was measured at room temperature and in different weight fractions and Reynolds numbers as in example 7. The results in Table 11 show that in general, the addition of GQD nanoparticles to water results in its convective heat transfer capability, although by an increase in concentration and due to agglomeration of nanoparticles, the percentage of improvement is reduced. Also, by an increase in Reynolds number, the convective heat transfer coefficient always experiences an upward trend. The most value of increase in h relative to the base fluid is the value of 20.3 percent in 3465 Reynolds with a concentration of 200 ppm.

TABLE 11
The effect of GQDs concentration on
convective heat transfer coefficient

| Concentration | | | | | |
|---|---|---|---|---|---|
| of GQDs | Weight | h (W/m²K) | | | |
| (ppm) | (wt %) | Re = 2795 | Re = 3465 | Re = 4248 | Re = 4918 |
| 0 | 0 | 1202 | 1325 | 1637 | 1878 |
| 50 | 0.005 | 1254 | 1416 | 1663 | 1935 |
| 100 | 0.01 | 1279 | 1498 | 1723 | 2004 |
| 200 | 0.02 | 1305 | 1594 | 1884 | 2115 |
| 300 | 0.03 | 1268 | 1579 | 1795 | 1982 |
| 500 | 0.05 | 1249 | 1551 | 1713 | 1976 |
| 1000 | 0.1 | 1228 | 1524 | 1659 | 1939 |

### EXAMPLE 15: THE STUDY OF THE EFFECT OF THE SIZE OF GRAPHENE QUANTUM DOT NANOPARTICLES ON THE THERMAL CONDUCTIVITY

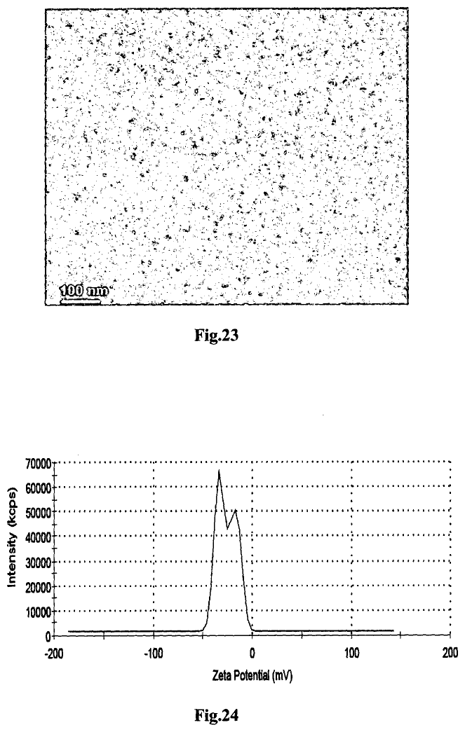

In order to study the effect of the size of graphene quantum dots on the capability of thermal conductivity of nanofluids, an experiment was performed in this area. First, the GQDs nanoparticles with a size of about 10 nm were separated by the use of chromatography column method. FIG. 22 shows the size distribution diagram of particles on the basis of dynamic light scattering analysis and FIG. 23 depicts the TEM image of GQD nanoparticles with a size of about 10 nm. FIG. 24 shows the stability analysis of graphene quantum dots with an average size of 10 nm and a specific peak within the range of −35 my shows the suitable stability of these nanoparticles.

Then, GQD/water nanofluid was prepared in three concentrations of 100, 200, and 400 ppm. Thermal conductivity coefficient (K) of the samples at room temperature (25° C.) was measured by the use of KD2 Labcell Ltd UK. To study the particle size effect, the obtained results and those of example 13 are presented in Table 12. The comparison of the results shows that by an increase in the size of GQD particles, the improvement rate of thermal conductivity coefficient of the nanofluids is slightly reduced.

TABLE 12
The effect of GQDs size on thermal conductivity of nano fluids

| | |
|---|---|
| Concentration | K (w/mk) |

| of GQDs | Weight | Size of GQDs | Size of GQDs |
|---|---|---|---|
| (ppm) | (wt %) | 1 nm | 10 nm |
| 0 | 0 | 0.560 | 0.560 |
| 100 | 0.01 | 0.577 | 0.571 |
| 200 | 0.02 | 0.593 | 0.584 |
| 400 | 0.04 | 0.611 | 0.598 |

### EXAMPLE 16: THE STUDY OF THE SIZE EFFECT OF GRAPHENE QUANTUM DOT NANOPARTICLES ON THE CONVECTIVE HEAT TRANSFER COEFFICIENT OF NANOFLUIDS

In this example, the size effect of graphene quantum dots on the convective heat transfer of nanofluids is studied. For this purpose, the GQD nanoparticles with a size of about 10 nm were separated by the use of chromatography column method. Then, the GQD/water nanofluid was prepared in three concentrations of 100, 200, and 300 ppm. The convective heat transfer coefficient in different Reynolds numbers was measured according to example 7 (Table 13). The comparison of the results with a concentration of 200 ppm presented in Table 14, showed that an 10-time increase in the size of the GQD nanoparticles brings about 2.1 percent reduction in the average increase of h relative to the base fluid.

TABLE 13
The effect of GQDs concentration on
convective heat transfer coefficient

| Consentration | | | | | |
|---|---|---|---|---|---|
| of GQDs | Weight | h (W/m²K) | | | |
| (ppm) | (wt %) | Re = 2795 | Re = 3465 | Re = 4248 | Re = 4918 |
| 0 | 0 | 1202 | 1325 | 1637 | 1878 |
| 100 | 0.01 | 1258 | 1472 | 1709 | 1966 |
| 200 | 0.02 | 1278 | 1561 | 1864 | 2070 |
| 300 | 0.03 | 1247 | 1556 | 1782 | 1957 |

TABLE 14
Comparison the effect of GQDs size on convective heat transfer coefficient

| Average size | Concentration | | | | | Average of |
|---|---|---|---|---|---|---|
| of GQDs | of GQDs | h (W/m²K) | | | | increase than |
| (nm) | (ppm) | Re = 2795 | Re = 3465 | Re = 4248 | Re = 4918 | base fluid (%) |
| 1 | 200 | 1305 | 1594 | 1884 | 2115 | 14.2 |
| 10 | 200 | 1278 | 1561 | 1864 | 2070 | 12.1 |

1. A fluid composition comprising a carbon dot and a base fluid, wherein the carbon dot comprises at least one of a carbon quantum dot, a graphene quantum dot, and a carbon nanotube dot with a particle size of about 10 nm or less.

2. The fluid composition of claim 1, wherein the size of carbon dots includes a size of from about 0.5 to about 10 nm.

3. The fluid composition of claim 1, wherein the carbon dot includes a size of from about 0.5 to about 5 nm.

4. The fluid composition of claim 1, wherein the carbon dots includes a size of from about 1 to about 5 nm.

5. The fluid composition of claim 1, wherein the base fluid comprises at least one of an oil compound, water, and alkylene glycol.

6. The fluid composition of claim 5, wherein the alkylene glycol comprises at least one of ethylene glycol and diethylene glycol.

7. The fluid composition of claim 5, wherein the oil compound comprises at least one of silicon oil and engine oil.

8. The fluid composition of claim 5, further comprising, a chemical or a non-chemical surfactant.

9. The fluid composition of claim 8, wherein the chemical or the non-chemical surfactant to the carbon dot include a ratio of from about 1:10 to about 2:1.

10. The fluid composition of claim 1, wherein the carbon dot is present in an amount of from about 0.0001 to about 0.1% by weight of the fluid composition.

11. A fluid composition comprising carbon dot comprising at least one of a carbon quantum dot and a graphene quantum dot with particle size of about 10 nm or less and a base fluid.

12. The fluid composition of claim 11, wherein the carbon dot includes a size of from about 0.5 to about 10 nm.

13. The fluid composition of claim 11, wherein the carbon dot includes a size of from about 0.5 to about 5 nm.

14. The fluid composition of claim 11, wherein the base fluid comprises at least one of water, an oil compound, and and alkylene glycol.

15. The fluid composition of claim 14, wherein the alkylene glycol comprises at least one of ethylene glycol and diethylene glycol.

16. The fluid composition of claim 14, wherein the oil compound comprises at least one of silicon oil and engine oil.

17. The fluid composition of claim 11, further comprising a chemical or a non-chemical surfactant.

18. The fluid composition of claim 17, wherein the chemical or the non-chemical surfactant to the carbon dot includes a ratio of from about 1:10 to about 2:1.

19. The fluid composition of claim 11, wherein the carbon dot is present in an amount of from about 0.0001 to about 0.1% by weight of the fluid composition.

20. A fluid composition comprising carbon dots and a base fluid, wherein the carbon dots are selected from a group consisting of a carbon quantum dots, a graphene quantum dots, and carbon nanotube dots with particle sizes of 10 nm or less.
